(19) United States
(12) Patent Application Publication
(10) Pub. No.: US 2018/0015686 A1
(43) Pub. Date: Jan. 18, 2018

(54) METHOD OF MAKING A MOISTURE-PERMEABLE AND WATERPROOF VAMP

(71) Applicants: HUGE DEVELOPMENT LIMITED, Hong Kong (CN); SHUANG BANG INDUSTRIAL CORP., Nantou City (TW)

(72) Inventors: Chung-Tang CHANG, Nantou City (TW); Ho-Pin LIN, Taichung City (TW)

(21) Appl. No.: 15/207,762

(22) Filed: Jul. 12, 2016

(51) Int. Cl. B32B 5/02; A43B 23/02; A43D 3/02; A43B 7/12; B32B 5/18; B32B 27/40; B32B 37/14

(52) U.S. Cl. CPC B32B 5/02; B32B 27/40; A43B 23/0205; A43B 23/026; B32B 37/14; A43B 7/125; B32B 5/18; A43D 3/02; B32B 2307/726; B32B 2307/73; B32B 2437/02

(57) ABSTRACT

A method of making a moisture-permeable and waterproof vamp for a shoe includes: coating a resin material on a release paper; solidifying the resin material to form a moisture-permeable and waterproof resin layer on an outer fabric layer so that the release paper is separated from the outer fabric layer; removing the release paper; attaching an inner fabric layer to the outer fabric layer so as to form a moisture-permeable and waterproof fabric laminate; cutting and forming the moisture-permeable and waterproof fabric laminate into a vamp that is formed with seams and provided with a receiving space adapted for receiving a user's foot; and applying a waterproof treatment to the seams.

### FIELD

The disclosure relates to a method of making a vamp for a shoe, and more particularly to a method of making a moisture-permeable and waterproof vamp for a shoe.

### BACKGROUND

Conventional shoes, such as walking shoes, sneakers or boots, may have a vamp made from fabrics, natural leather or synthetic leather. The shoes with the fabric or natural leather vamp have the advantages of breathability and perspiration repellence, but are not water resistant. The shoes with the synthetic leather vamp have the advantage of water resistance, but are defective in breathability and often cause a sweltering feeling. Besides, the water-resistant effect of the conventional shoes cannot be comprehensively achieved without application of strips made from a waterproof material or waterproof adhesive to seams of the synthetic leather vamp.

The galoshes are generally made from a waterproof rubber material in one piece without formation of seams by injection molding techniques. Since the rubber material is relatively dense, the conventional galoshes are relatively rigid, heavy and moisture-impermeable. After wearing the galoshes for a long time, a user may experience discomfort from sweltering feelings.

### SUMMARY

Therefore, an object of the disclosure is to provide a method of making a moisture-permeable and waterproof vamp for a shoe that can alleviate at least one of the drawbacks of the prior art.

According to one aspect of the disclosure, the method of making a moisture-permeable and waterproof vamp for a shoe includes: coating a resin material on a release paper; solidifying the resin material to form a moisture-permeable and waterproof resin layer on a first surface of an outer fabric layer so that the release paper is separated from the outer fabric layer; removing the release paper; forming an inner fabric layer on a second surface of the outer fabric layer that is opposite to the first surface so as to form a moisture-permeable and waterproof fabric laminate; cutting and forming the moisture-permeable and waterproof fabric laminate into a vamp that is formed with seams and provided with a receiving space adapted for receiving a user's foot; and applying a waterproof treatment to the seams.

Another object of the disclosure is to provide a method of making a moisture-permeable and waterproof shoe.

According to another aspect of the disclosure, the method for making a moisture-permeable and waterproof shoe includes: preparing a moisture-permeable and waterproof vamp according to the abovementioned method; disposing a shoe last in the receiving space of the vamp for maintaining a configuration of the vamp; attaching a shoe sole to a bottom of the vamp; and removing the shoe last from the receiving space.

### BRIEF DESCRIPTION OF THE DRAWINGS

Other features and advantages of the disclosure will become apparent in the following detailed description of the embodiments with reference to the accompanying drawings, of which:

FIG. 1 is a flow chart illustrating consecutive steps of an embodiment of a method of making a moisture-permeable and waterproof vamp for a shoe according to the disclosure;

FIG. 2 is a schematic view illustrating formation of a moisture-permeable and waterproof resin layer of the method shown in FIG. 1;

FIG. 3 is a schematic view illustrating attaching of an outer fabric layer to the moisture-permeable and waterproof resin layer of the method shown in FIG. 1;

FIG. 4 is a schematic view illustrating removing of a release paper of the method shown in FIG. 1;

FIG. 5 is a schematic view illustrating formation of a moisture-permeable and waterproof fabric laminate of the method shown in FIG. 1;

FIGS. 6 and 7 are schematic views illustrating formation of a vamp of the method shown in FIG. 1;

FIG. 8 is a schematic view illustrating an embodiment of a method for making a moisture-permeable and waterproof shoe according to the disclosure;

FIG. 9 is a schematic view illustrating removing of a shoe last from the shoe of the embodiment of FIG. 8; and

FIGS. 10 to 12 are perspective views illustrating exemplified appearances of the embodiment of FIG. 8.

### DETAILED DESCRIPTION

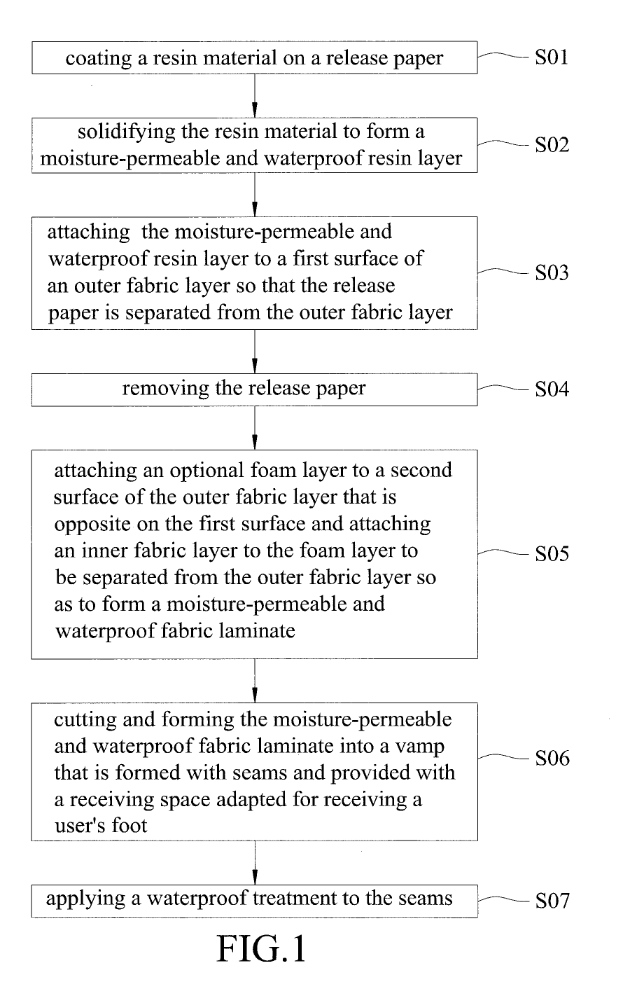

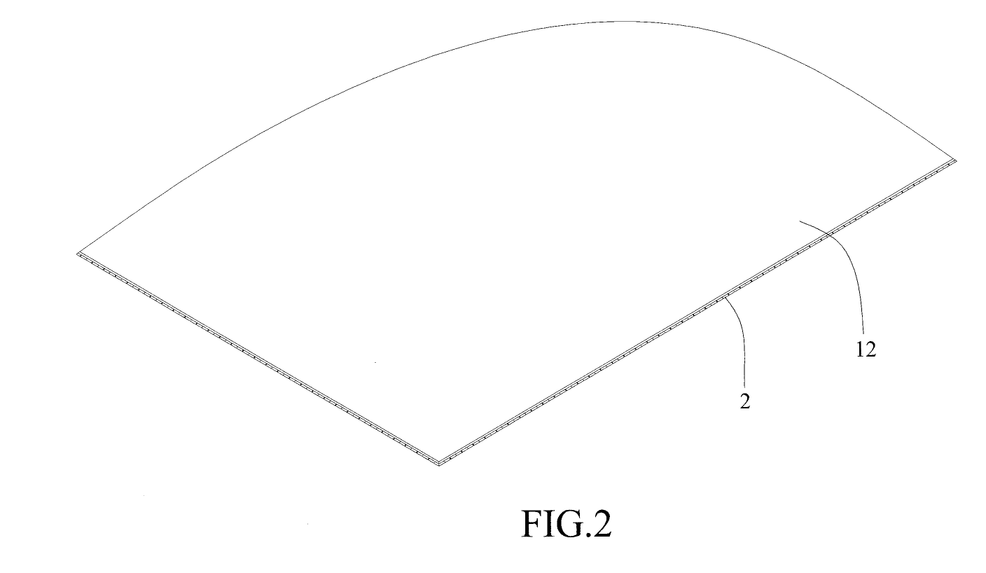

Referring to FIGS. 1 and 2, an embodiment of a method of making a moisture-permeable and waterproof vamp for a shoe according to the disclosure begins with coating a resin material on a release paper 2 (step S01). Then, in step S02, the resin material coated on the release paper 2 is solidified to form a moisture-permeable and waterproof resin layer 12. For instance, the release paper 2 may be placed in an oven together with the resin material coated thereon at a predetermined heating temperature for a predetermined heating time to form the moisture-permeable and waterproof resin layer 12. In one embodiment, the moisture-permeable and waterproof resin layer 12 may have a thickness ranging from 25 μm to 50 μm. In one embodiment, the resin material maybe polyurethane (PU) resin. The heating temperature and time are adjustable based on the required thickness and composition of the resin material. For instance, the heating temperature and time may range from 50° C. to 180° C. and 1 minute to 30 minutes, respectively. In one embodiment, the release paper 2 maybe embossed with a pattern, such that the moisture-permeable and waterproof resin layer 12 formed thereon has an embossed surface that contacts the release paper 2 and that has a pattern corresponding to that of the release paper 2.

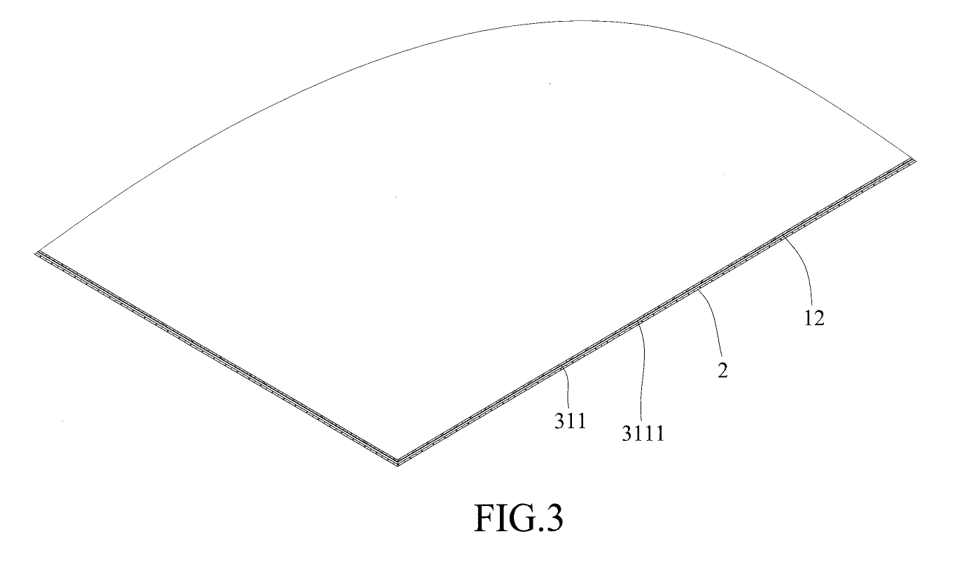

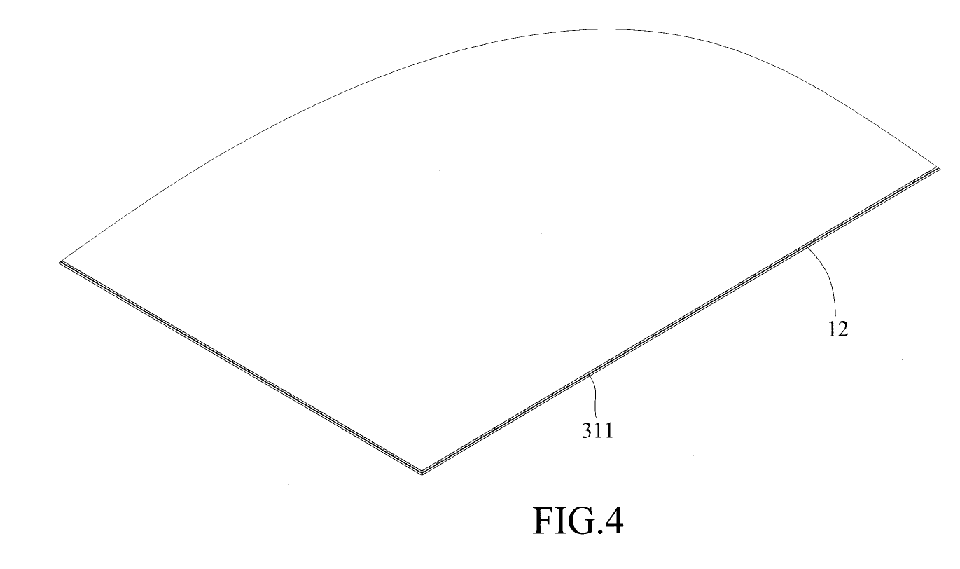

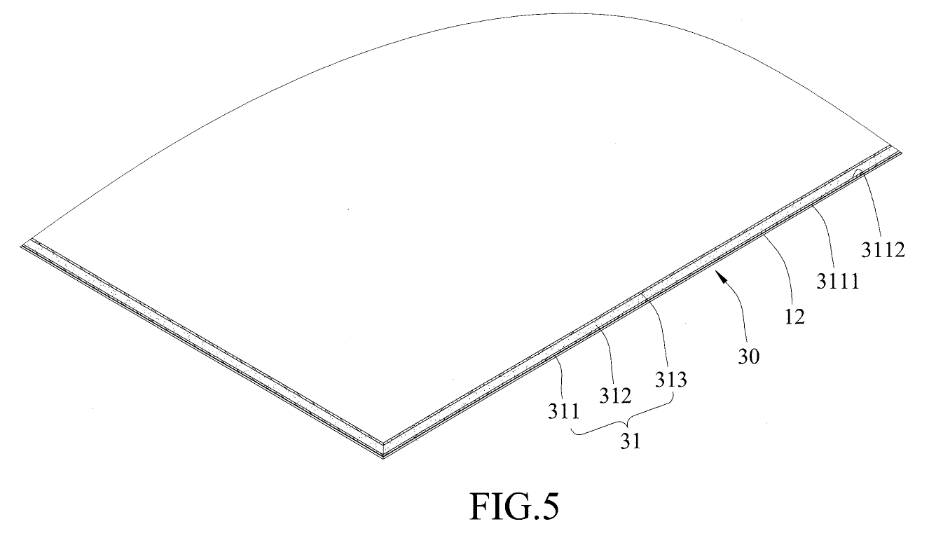

Then, referring to FIGS. 1, 3, 4 and 5, in step S03, the moisture-permeable and waterproof resin layer 12 is attached to a first surface 3111 of an outer fabric layer 311 so that the release paper 2 is separated from the outer fabric layer 311. Then, in step S04, the release paper 2 is removed, and in step S05, an optional foam layer 312 is attached to a second surface 3112 of the outer fabric layer 311 that is opposite to the first surface 3111, followed by attaching an inner fabric layer 313 to the foam layer 312 to be separated from the outer fabric layer 311 so that the foam layer 312 is interposed between the inner fabric layer 313 and the outer fabric layer 311 and so that a moisture-permeable and waterproof fabric laminate 30 is formed. In one embodiment, the moisture-permeable and waterproof resin layer 12 may be attached to the outer fabric layer 311 using an adhesive.

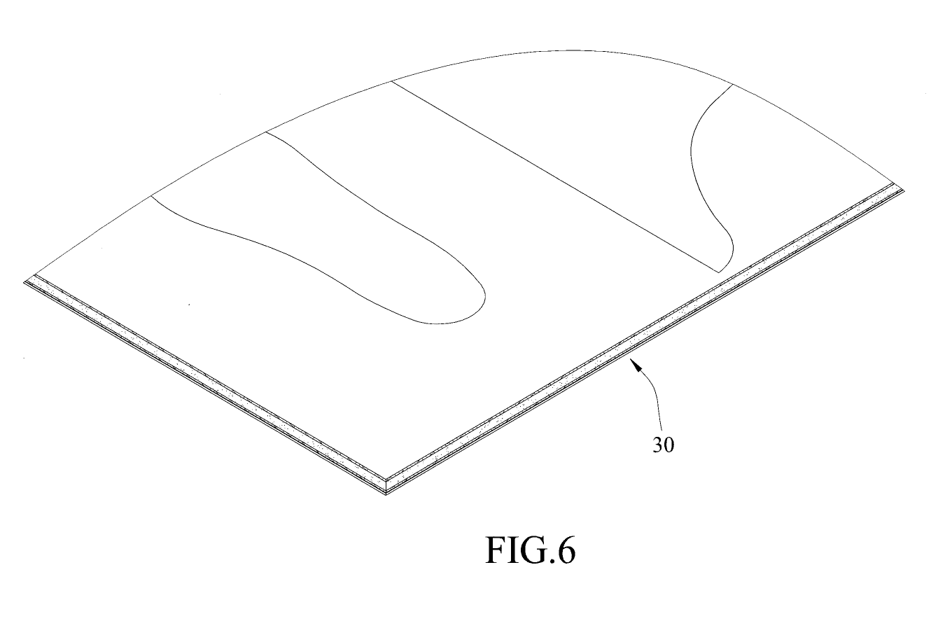

Referring to FIGS. 1, 6 and 7, step S06 is then performed to cut the moisture-permeable and waterproof fabric laminate 30 into a plurality of vamp-making pieces and to sew the vamp-making pieces together to form a vamp 3. The vamp 3 has seams 34 and is provided with a receiving space 33 adapted for receiving a user's foot.

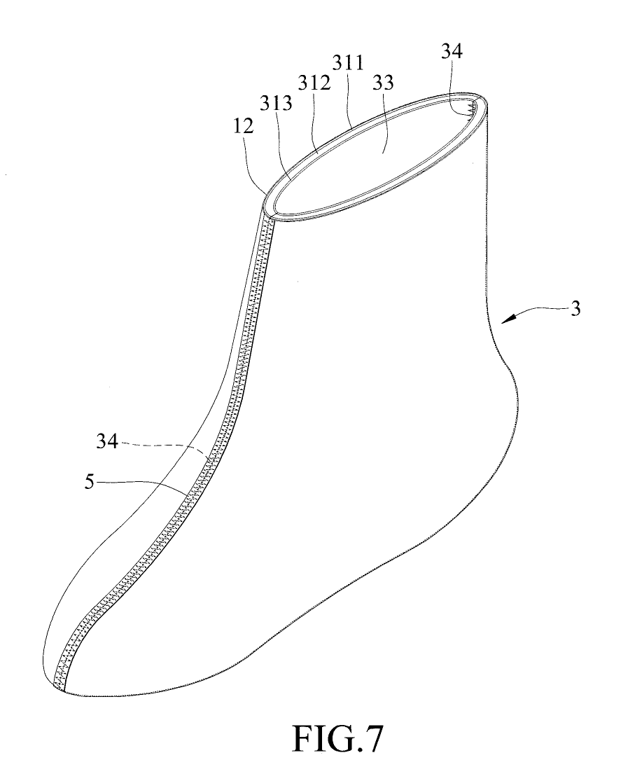

Referring to FIGS. 1 and 7, step S07 is then performed to apply a waterproof treatment to the seams 34. In one embodiment, the waterproof treatment is conducted by forming a waterproof layer 5 on an outer surface of the moisture-permeable and waterproof resin layer 12 that is opposite to the outer fabric layer 311 such that the seams 34 are covered by the waterproof layer 5. Alternatively, the waterproof treatment may be conducted by forming the waterproof layer 5 on a surface of the inner fabric layer 313 that is opposite to the outer fabric layer 311 such that the seams 34 are covered by the waterproof layer 5. The waterproof layer 5 may be formed by coating of a waterproof glue or attachment of a waterproof strip.

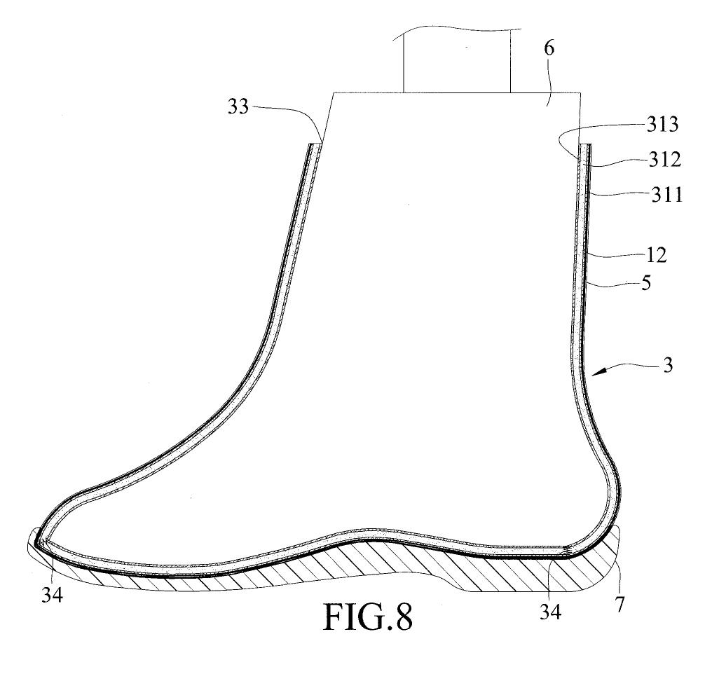

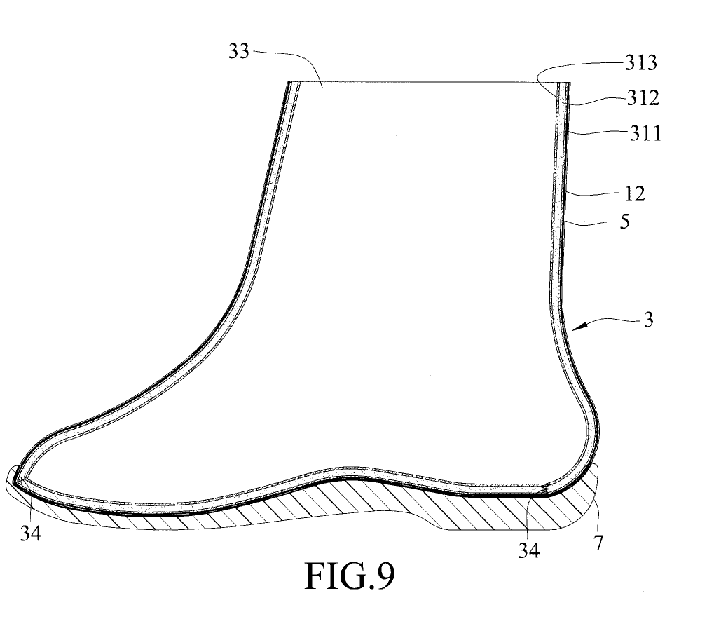

Referring to FIGS. 8 and 9, an embodiment of a method of making a shoe with the aforementioned vamp 3 includes preparing the abovementioned moisture-permeable and waterproof vamp 3, followed by disposing a shoe last 6 in the receiving space 33 of the vamp 3 for maintaining a configuration of the vamp 3, then attaching a shoe sole 7 to a bottom of the vamp 3, and then removing the shoe last 6 from the receiving space 33.

The moisture-permeable and waterproof resin layer 12 of the vamp 3 may have different structures due to selection of the resin material. For example, the moisture-permeable and waterproof resin layer 12 may be in the form of a porous membrane or non-porous membrane. The porous membrane has a plurality of pores, each of which has a diameter smaller than that of a water molecule and larger than that of a water vapor molecule. By way of a proper pore size arrangement, the porous membrane is waterproof and moisture-permeable. The non-porous membrane is free of pores and has a hydrophilic functional group-providing side and a hydrophobic functional group-providing side. When the non-porous member serves as the moisture-permeable and waterproof resin layer 12, the water vapor molecules will be adsorbed on the hydrophilic functional group-providing side, diffused to the hydrophobic functional group-providing side through capillary action and finally transpired to the environment.

As for the properties of the moisture-permeable and waterproof resin layer 12, the layer 12 may have a water resistance greater than 2000 mm as measured by the method in accordance with JIS L-1092B, and a moisture permeability greater than 2000 g/m³/24 hr as measured by the method in accordance with JIS L-1099B1.

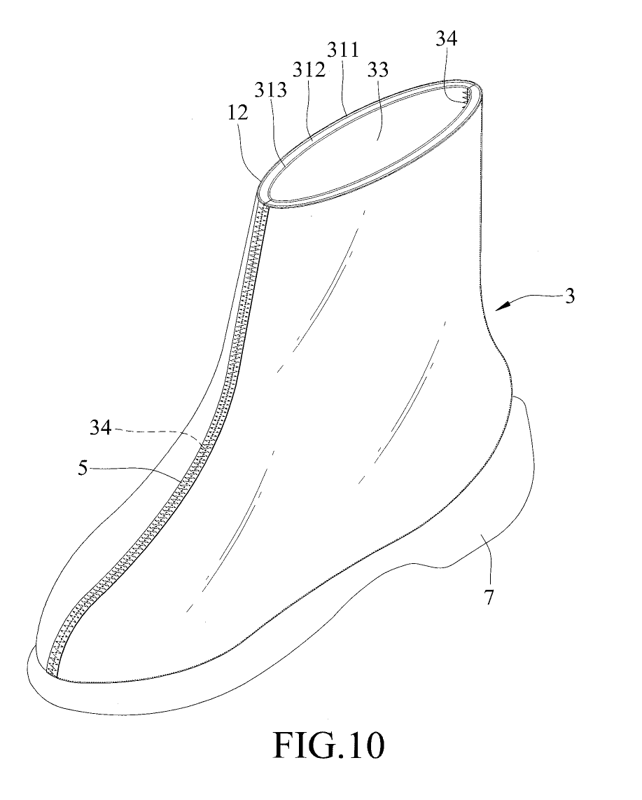

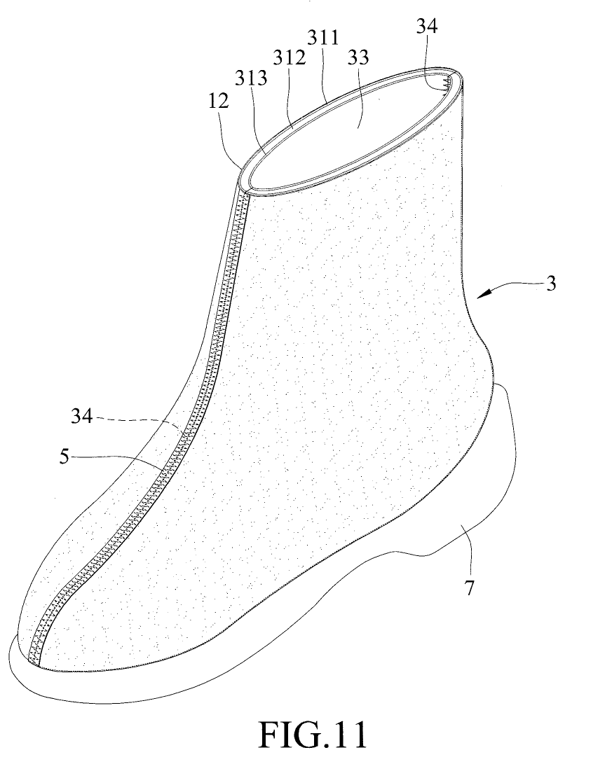

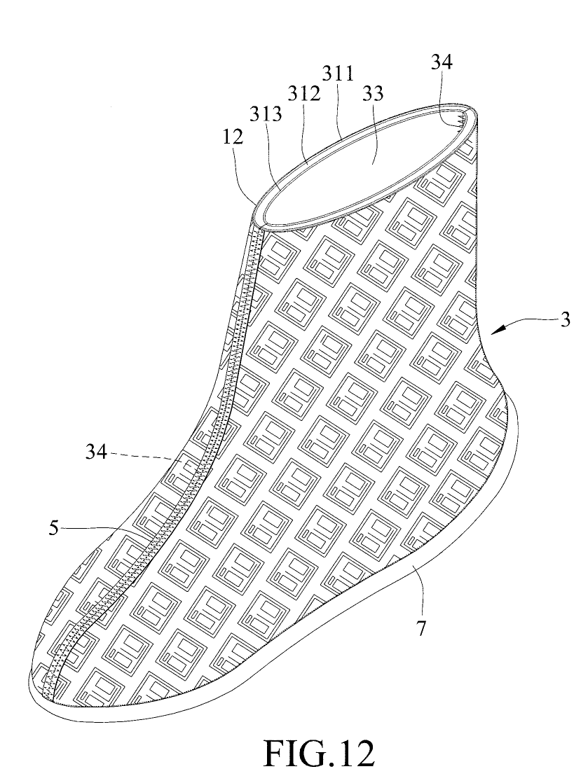

Referring to FIGS. 10 and 11, the first surface 3111 of the outer fabric layer 311 may be subjected to a surface treatment in cooperation with texture modification of the moisture-permeable and waterproof resin layer 12, and the vamp 13 may exhibit different appearances, such as a glossy or matte appearance. Referring to FIG. 12, alternatively, the first surface 3111 of the outer fabric layer 311 may be embossed or patterned and the moisture-permeable and waterproof resin layer 12 may be made from a transparent resin material, and the vamp 3 may have different appearances. Besides, the color and configuration of the waterproof layer 5 may also vary based on the intended designs.

It is noted that based on the intended application and requirements, an additive, such as a pigment, a UV absorber, or an antibacterial agent, may be added to the resin material so that the waterproof and moisture-permeable resin layer 12 may achieve one or more of hyperchromic, ultraviolet resistant and antibacterial effects, etc.

Moreover, incorporation of the foam layer 312 would allow for the shoe to be soft, comfortable and lightweight for wearing. In one form, the foam layer 312 is omitted so that the outer fabric layer 311 is in direct contact with the inner fabric layer 312.

In summary, compared with the conventional shoes made from the fabrics, the natural leather or the synthetic leather, with the moisture-permeable and waterproof resin layer 12 and the waterproof layer 5 covered on the seams 34, the vamp 3 of the shoe of this disclosure is both waterproof and moisture-permeable. Besides, the step of cutting and forming the moisture-permeable and waterproof fabric laminate 30 into the vamp 3 makes the vamp 3 more flexible to match with designs and property requirements of different shoes, and the requirement for developing molds for different shoes can be eliminated. The structural arrangement of the outer fabric layer 311, the foam layer 312 and the inner fabric layer 313 makes the moisture-permeable and waterproof fabric laminate 30 of the shoe relatively lightweight and comfortable for wearing. Surface treatment performed on the release paper 2 or the first surface 3111 of the outer fabric layer 311, such as embossing or patterning, or changes made to the color or design of the waterproof layer 5 makes the appearance of the vamp 3 of the shoe more changeable so as to increase the aesthetic value of the shoe.

In the description above, for the purposes of explanation, numerous specific details have been set forth in order to provide a thorough understanding of the embodiments. It will be apparent, however, to one skilled in the art, that one or more other embodiments may be practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects.

While the disclosure has been described in connection with what are considered the exemplary embodiments, it is understood that this disclosure is not limited to the disclosed embodiments but is intended to cover various arrangements included within the spirit and scope of the broadest interpretation so as to encompass all such modifications and equivalent arrangements.

What is claimed is:

1. A method of making a moisture-permeable and waterproof vamp for a shoe, comprising:
coating a resin material on a release paper;
solidifying the resin material to form a moisture-permeable and waterproof resin layer;
attaching the moisture-permeable and waterproof resin layer to a first surface of an outer fabric layer so that the release paper is separated from the outer fabric layer;
removing the release paper;
attaching an inner fabric layer to a second surface of the outer fabric layer that is opposite to the first surface so as to form a moisture-permeable and waterproof fabric laminate;
cutting and forming the moisture-permeable and waterproof fabric laminate into a vamp that is formed with seams and provided with a receiving space adapted for receiving a user's foot; and
applying a waterproof treatment to the seams.

2. The method of claim 1, wherein, prior to attaching of the inner fabric layer to the second surface of the outer fabric layer, a foam layer is attached to the second surface of the outer fabric layer so that the foam layer is interposed between the inner fabric layer and the outer fabric layer.

3. The method of claim 1, wherein the resin layer has a water resistance greater than 2000 mm as measured by the method in accordance with JIS L-1092B.

4. The method of claim 1, wherein the resin layer has a moisture permeability greater than 2000 g/m²/24 hr as measured by the method in accordance with JIS L-1099B1.

5. The method of claim 1, wherein the resin material includes polyurethane resin.

6. The method of claim 1, wherein the waterproof treatment is conducted by forming a waterproof layer on the moisture-permeable and waterproof resin layer such that the seams are covered by the waterproof layer and the waterproof layer is disposed opposite to the outer fabric layer.

7. The method of claim 1, wherein the waterproof treatment is conducted by forming a waterproof layer on the inner fabric layer such that the seams are covered by the waterproof layer and the waterproof layer is disposed opposite to the outer fabric layer.

8. The method of claim 1, wherein the release paper is embossed with a pattern, such that the resin layer has an embossed surface that contacts the release paper and that has a pattern corresponding to that of the release paper.

9. The method of claim 1, wherein the first surface of the outer fabric layer is embossed or patterned.

10. The method of claim 1, wherein the resin layer has an outer surface that is opposite to the outer fabric layer and that exhibits a glossy appearance.

11. The method of claim 1, wherein the resin layer has an outer surface that is opposite to the outer fabric layer and that exhibits a matte appearance.

12. The method of claim 1, wherein the resin layer has a thickness ranging from 25 μm to 50 μm.

13. A method for making a moisture-permeable and waterproof shoe, comprising
Preparing a moisture-permeable and waterproof vamp according to the method of claim 1; and
disposing a shoe last in the receiving space of the vamp for maintaining a configuration of the vamp;
attaching a shoe sole to a bottom of the vamp; and
removing the shoe last from the receiving space.
